(19) United States
(12) Patent Application Publication
(10) Pub. No.: US 2013/0311276 A1
(43) Pub. Date: Nov. 21, 2013

(54) METHODS FOR VOICE ACTIVATED ADVERTISEMENT COMPRESSION AND DEVICES THEREOF

(71) Applicants: Stan Wei Wong, JR., Austin, TX (US); Colin Jenkins, Westfield, NJ (US); Arnab Chaudhuri, Cleveland Heights, OH (US); Joseph Smetona, New York, NY (US); Renato Tranquilino, New York, NY (US)

(72) Inventors: Stan Wei Wong, JR., Austin, TX (US); Colin Jenkins, Westfield, NJ (US); Arnab Chaudhuri, Cleveland Heights, OH (US); Joseph Smetona, New York, NY (US); Renato Tranquilino, New York, NY (US)

(21) Appl. No.: 13/897,097

(22) Filed: May 17, 2013

Related U.S. Application Data
(60) Provisional application No. 61/648,994, filed on May 18, 2012.

(51) Int. Cl. G06Q 30/02

(52) U.S. Cl. CPC G06Q 30/0251
USPC 705/14.49

(57) ABSTRACT

A method, non-transitory computer readable medium and apparatus for voice activated advertisement compression includes outputting by an end user computing device one of one or more items of advertising content associated with requested content. During the outputting of the one of the one or more items of advertising content any captured audio input is converted into a converted audio input. A determination is made whether the converted audio input matches stored information associated with the one of the items of advertising content being output. An action with respect to the one of the items of advertising content being output is executed when the determination indicates a match between the converted audio input and the stored information.

This application claims the benefit of U.S. Provisional Patent Application Ser. No. 61/648,994 filed May 18, 2012, which is hereby incorporated by reference in its entirety.

### FIELD

This technology generally relates to methods and devices for the management of displayed content. More particularly, this technology relates to methods and devices for voice activated advertisement compression.

### BACKGROUND

When online content is requested, content providers often provide one or more advertisements, along with the requested content, to the end user computing device. In some cases, the requested content is not permitted to be displayed on the end user computing device until the presentation of all of the advertisements is complete.

Currently, systems exist that allow at least a portion of an advertisement to be skipped if the end user correctly types in an answer to a challenge or question. One example is the system illustrated and disclosed in US Patent Application Publication No. 2012/0166294 for a “System and Method for Skippable Pre-Roil Video Advertising”. It is unclear whether this typed in response alone improves long term retention of the advertisement. Moreover, when an operator of an end user computing device types in a field, brand retention is limited to this end user. Further, the implementations of some prior systems require changes to websites that include changing the service that provides the advertisements.

### SUMMARY

A method for voice activated advertisement compression applies when the end user computing device outputs one or more items of advertising content associated with requested content. When one of the items of advertising content is output, the end user computing device will provide a prompt that requests stored information associated with that item of advertising content to be spoken. For example, the stored information may be an advertising line, such as a brand name, brand tagline, or any other brand message, to be spoken. During this process, any captured audio input is converted by the end user computing device to a converted audio input. The end user computing device determines whether the converted audio input matches the stored information associated with the item of advertising content being output. An action with respect to the item of advertising content being output is executed by the end user computing device when the determination indicates the match between the converted audio input and the stored information. For example, the action may be to skip some or all of the item of advertising content being output and proceed to another advertisement or the requested content.

A non-transitory computer readable medium, having stored thereon instructions for voice activated advertisement compression comprised of machine executable code which, when executed by at least one processor, causes the processor to perform steps including outputting one or more items of advertising content associated with requested content. When one of the items of advertising content is being output a prompt is provided that requests stored information associated with that item of advertising content to be spoken. For example, the stored information may be an advertising line, such as a brand name, brand tagline, or any other brand message, to be spoken. During this process, any captured audio input is converted to a converted audio input. A determination is made whether the converted audio input matches the stored information associated with the item of advertising content being output. An action with respect to the item of advertising content being output is executed when the determination indicates the match between the converted audio input and the stored information. For example, the action may be to skip some or all of the item of advertising content being output and proceed to another advertisement or the requested content.

A voice activated advertisement compression computing apparatus includes one or more processors and memory. The one or more processors are configured to execute programmed instructions stored in the memory including outputting one or more items of advertising content associated with requested content. When one of the items of advertising content is being output a prompt is provided that requests stored information associated with that item of advertising content to be spoken. For example, the stored information may be an advertising line, such as a brand name, brand tagline, or any other brand message, to be spoken. During this process, any captured audio input is converted to a converted audio input. A determination is made whether the converted audio input matches the stored information associated with the item of advertising content being output. An action with respect to the item of advertising content being output is executed when the determination indicates the match between the converted audio input and the stored information. For example, the action may be to skip some or all of the item of advertising content being output and proceed to another advertisement or the requested content.

With this technology, a correct voice response captured by the end user computing device to skip part or all of an advertisement leads to a greater likelihood of retention by the operator of the end user computing device, than prior systems which only require a typed in input. This promotes greater brand awareness. Additionally, the use of a voice response, as opposed to a typed in input viewable only by the operator, provides a greater likelihood of promoting brand awareness to others in the vicinity of the operator of the end user computing device. Further, this technology can be easily implemented through a simple download to the end user computing device.

### BRIEF DESCRIPTION OF THE DRAWINGS

FIG. 1 is a block diagram of an exemplary environment with a voice activated advertisement compression system incorporated within an end user computing device;

FIG. 2(a) is a block diagram of the end user computing device with the voice activated advertisement compression system;

FIG. 2(b) is a functional block of the exemplary environment with the voice activated advertisement compression system incorporated within the end user computing device; and

FIG. 3 is a flowchart of an exemplary method for voice activated advertisement compression.

### DETAILED DESCRIPTION

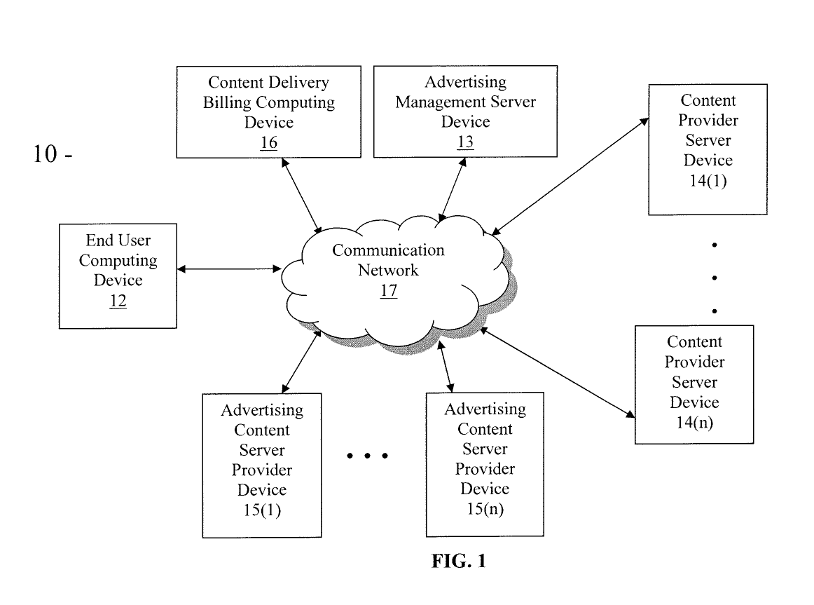

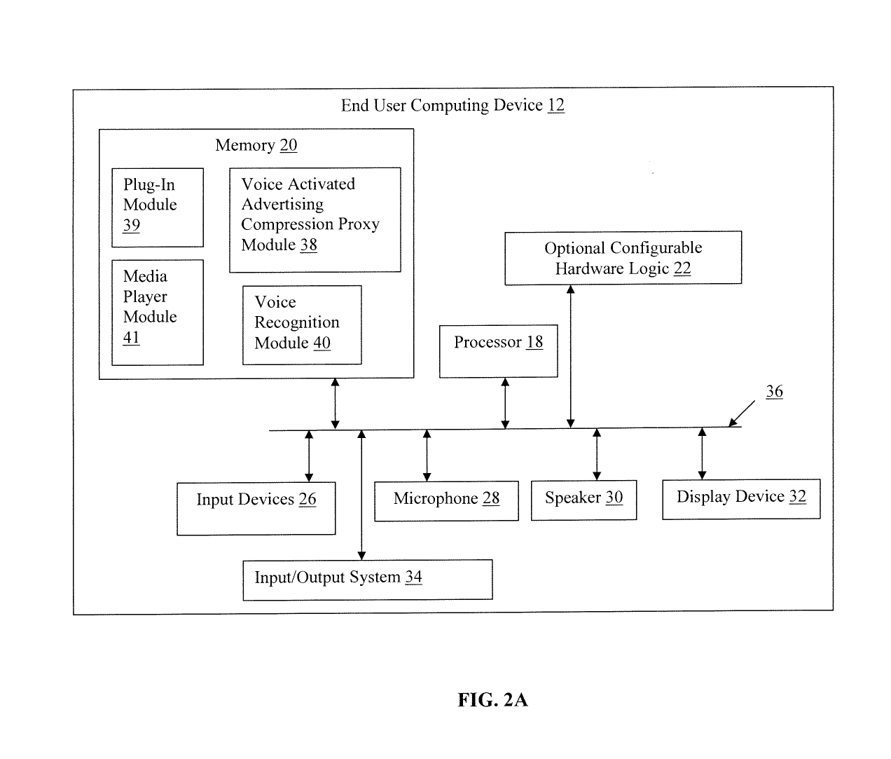

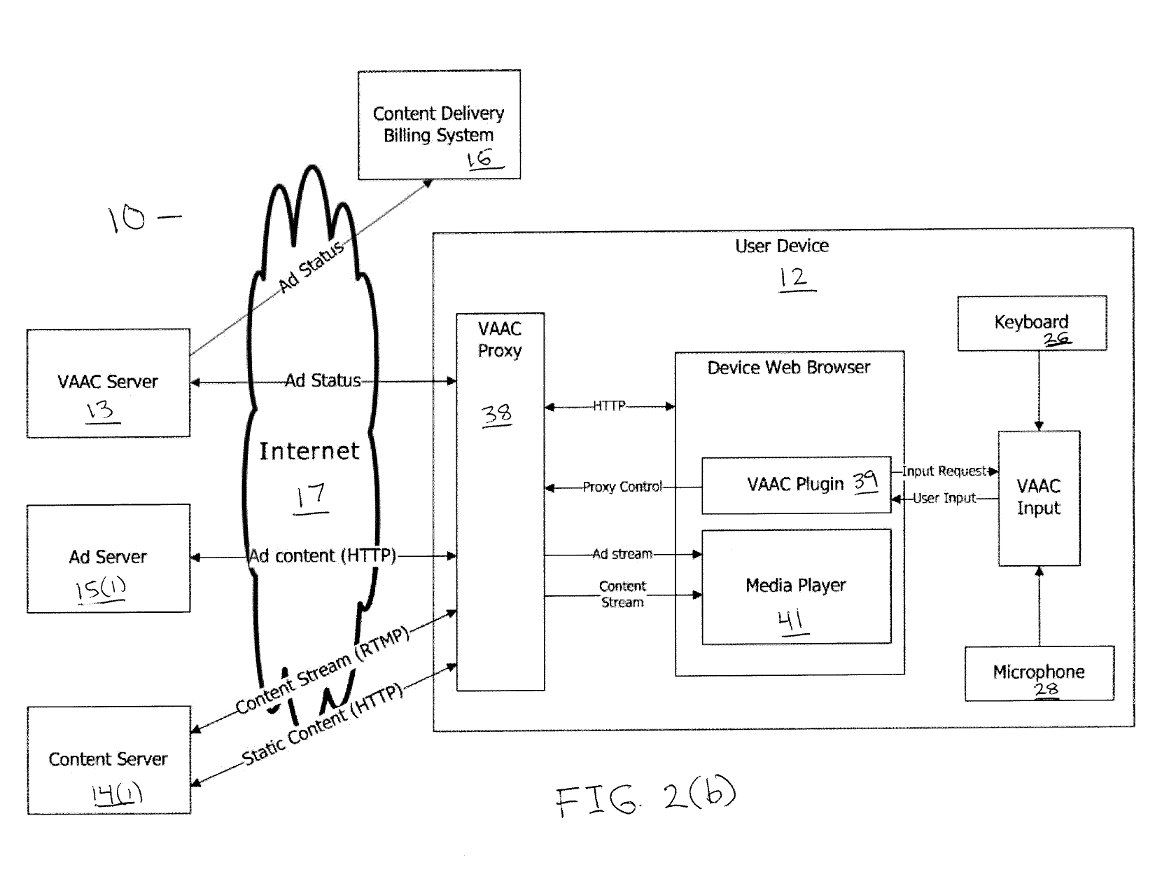

An environment 10 with an end user computing device 12, which has an exemplary voice activated advertisement compression system, is illustrated in FIGS. 1 and 2(a)-2(b). The environment 10 includes the end user computing device 12, an advertising management server device 13, a plurality of content provider server devices 14(1)-14(n), a plurality of advertising content provider server devices 15(1)-15(n), a content delivery billing computing device 16, and a communication network 17, although the environment could include other types and numbers of systems, devices, components, and other elements.

Referring more specifically to FIGS. 1 and 2(a)-2(b), in this example, the end user computing device 12 is a smart phone, although other types of mobile or stationary end user computing devices could be used, such as a tablet, laptop computer, desktop computer, or interactive television. Although in this example, only one end user computing device 12 is illustrated, this technology can be used with other types and numbers of computing devices and other computing systems. The end user computing device 12 includes a central processing unit (CPU) or processor 18, a memory 20, optional configurable hardware logic 22, input devices 26, a microphone 28, a speaker 30, a display device 32, and a input/output system 34 which are coupled together by a bus or other link 36, although other numbers and types of systems, devices, components, and elements in other configurations and locations can be used.

The processor 18 in the end user computing device 12 executes a program of stored instructions for one or more aspects of the present technology as described and illustrated by way of the examples herein, although other types and numbers of processing devices and logic could be used and the processor 18 could execute other numbers and types of programmed instructions.

The memory 20 in the end user computing device 12 stores these programmed instructions for one or more aspects of the present technology as described and illustrated herein. In this example, the memory 20 of the end user computing device 12 has a voice activated advertising compression proxy module 38 which comprises programmed instructions as illustrated and described herein, as well as a voice recognition module 40, although the memory can comprise other types and numbers of modules. The voice activated advertising compression proxy module 38 may also be optionally configured to have a third party voice recognition module. To improve voice recognition capability, the voice recognition module 40 may be configured to permit an operator to calibrate and/or train the voice recognition module 40 to the voice of the operator. The plug-in module 39 may be configured to manage interactions and input requests for, and from, one of the input devices 26 and the microphone 28 in conjunction with this exemplary method as illustrated and described herein, although the module may perform other types and numbers of functions and other operations. The media player module 41 may playback media files, although the media player module may provide other types and numbers of functions and other types and numbers of media players could be used. Some or all of the programmed instructions and/or modules may also be stored and/or executed elsewhere. A variety of different types of memory storage devices, such as a random access memory (RAM) and/or read only memory (ROM) in the end user computing device 12 or a hard disk, CD ROM, DVD ROM, or other computer readable medium which is read from and written to by a magnetic, optical, or other reading and writing system that is coupled to the processor 18 in the end user computing device 12, can be used for the memory 20.

The optional configurable hardware logic 22 of the end user computing device 12 may comprise specialized hardware configured to be capable of implementing one or more steps of this technology as illustrated and described with reference to the examples herein. By way of example only, the optional configurable logic may comprise one or more of field programmable gate arrays (FPGAs), field programmable logic devices (FPLDs), application specific integrated circuits (ASICs) and/or programmable logic units (PLUs).

The input devices 26 of the end user computing device 12 include a keyboard and a computer mouse that enable a user to interact with and/or enter data into the end user computing device 12, although other types and numbers of wired and wireless input devices could be used, such as an interactive touch screen. The microphone of the end user computing device 12 is able to capture audio input, although other types and numbers of wired and wireless audio input devices could be used. The speaker 30 of the end user computing device 12 is able to provide audio output, although other types and numbers of audio output devices could be used. The display device 32 of the end user computing device 12 is an LED screen or LCD screen by way of example only, although other types and numbers of display devices which have other functionality could be used, such as interactive touch screens or cathode ray tube displays by way of example only.

In one example, the input/output system 34 of the end user computing device 12 operatively couples and facilitates communication between the end user computing device 12, the advertising management server device 13, the content provider server devices 14(1)-14(n), the plurality of advertising content provider server devices 15(1)-15(n), and the content delivery billing computing device 16 via the communication network 17, although other types and numbers of systems, devices, databases, components, or other elements as well as other types and numbers of communication networks or systems can be used. By way of example only, the communication network could use TCP/IP over Ethernet and industry-standard protocols, including NFS, CIFS, SOAP, XML, LDAP, and/or SNMP, although other types and numbers of communication networks, such as a direct connection, a local area network, a wide area network, each having their own communications protocols, can be used.

The advertising management server device 13, each of the content provider server devices 14(1)-14(n), each of the plurality of advertising content provider server devices 15(1)-15(n), and the content delivery billing computing device 16 can each include a central processing unit (CPU) or processor, a memory, and a input/output system which are coupled together by a bus or other link, although other numbers and types of each of these devices could be used. The advertising management server device 13 will provide associated advertising lines for the items of advertising content and manage storing and/or analyzing information gathered during this process, although the advertising management server device 13 can perform other types and numbers of functions and operations, including one or more aspects of the technology as illustrated and described with reference to the example herein. Each of the content provider server devices 14(1)-14(n) may manage and provide responsive requested content, including, but not limited to advertising content and associated advertising lines for the items of advertising content, although the content provider server devices 14(1)-14(n) can manage and provide other types and numbers of functions and operations. Each of the plurality of advertising content provider server devices 15(1)-15(n) may manage and provide advertising content, including, but not limited to the associated advertising lines for the items of advertising content, although the plurality of advertising content provider server devices 15(1)-15(n) can manage and provide other types and numbers of functions and operations. Advertising content can also be obtained from other sources, such as one of the plurality of content provider server devices 14(1)-14(n) by way of example only. The content delivery billing computing device 16 may manage analyzing stored information relating to the use of this technology and compensation, although the content billing computing device 16 can have other types and numbers of functions and other operations.

Although an example of the end user computing device 12, the advertising management server device 13, the content provider server devices 14(1)-14(n), the plurality of advertising content provider server devices 15(1)-15(n), and the content delivery billing computing device 16 are described herein, it is to be understood that the devices and systems of the examples described herein are for exemplary purposes, as many variations of the specific hardware and software used to implement the examples are possible, as will be appreciated by those skilled in the relevant art(s). In addition, two or more computing systems or devices can be substituted for any one of the systems or devices in any embodiment of the examples.

The examples may also be embodied as a non-transitory computer readable medium having instructions stored thereon for one or more aspects of the present technology as described and illustrated by way of the examples herein, as described herein, which when executed by a processor, cause the processor to carry out the steps necessary to implement the methods of the examples, as described and illustrated herein.

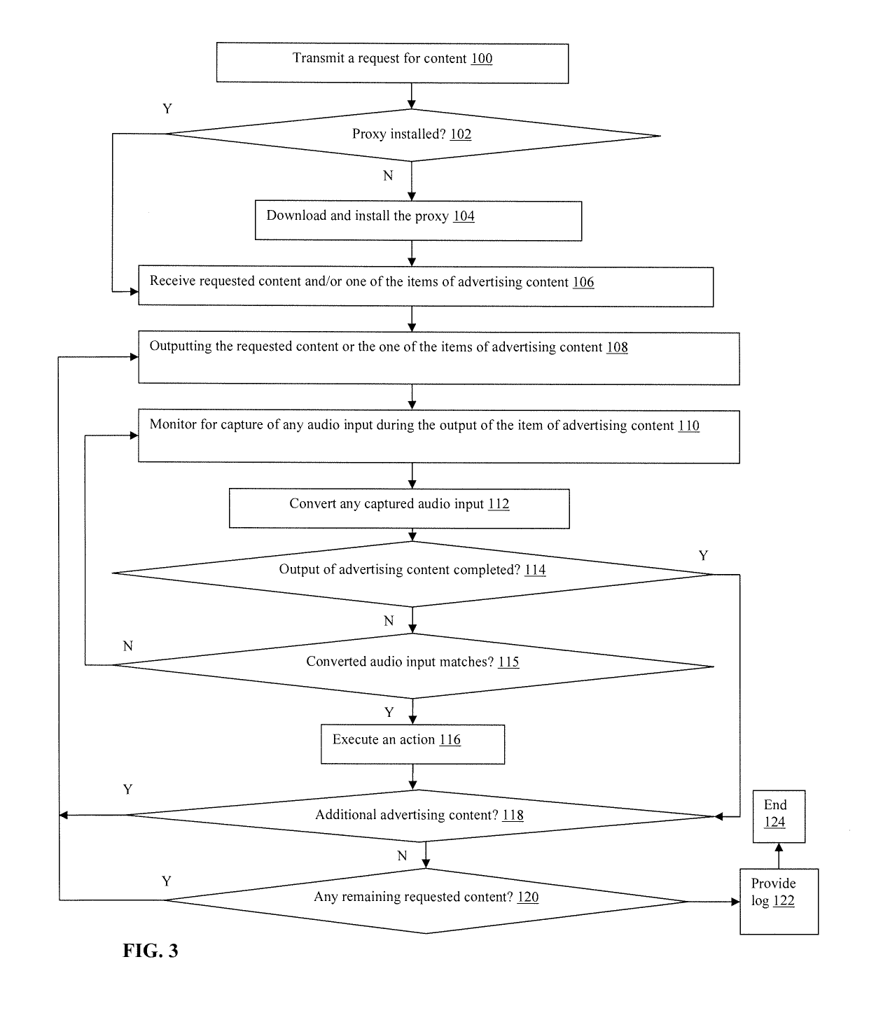

An exemplary method for voice activated advertisement compression will now be described with reference to FIGS. 1-3. In step 100, the end user computing device 12 may transmit a request for content from one of the content provider server devices 14(1)-14(n), although the content can be obtained in other manners by other types and numbers of systems and/or devices. By way of example only, the requested content may be a movie, a video, music, a TV show, a web page or other streamed or fixed content, although the end user computing device 12 can obtain other types and amounts of content. In this example, the content provider server devices 14(1)-14(n) store the requested content in a standard format, such as mpeg, avi, mpg-2, fly, way, mov, mp4, and mp2 by way of example only, although other formats could be used and the content could be stored and retrieved from other locations. The requested content also may include information which specifies when an item of advertising content can be output during the play of the requested content. In this example, the requested content may be associated with one or more items of advertising content, such as video, audio, or banner advertisements by way of example only, although the requested content could be associated with other types and amounts of content. Additionally, in this example, each of the content server provider devices 14(1)-14(n) store content which may be requested, such as associated items of advertising content, and the associated items of advertising content may be stored in one or more of the advertising content provider server devices 15(1)-15(n), although the advertising content can be obtained from other sources, such as one of the plurality of content provider server devices 14(1)-14(n) and other configurations could be used as well. Each item of advertising content also could be stored in multiple versions, such as full length, cut-down, or condensed, by way of example only, although the items of advertising content can be stored in other manners. Further, in this example, the advertising line associated with each item of advertising content is stored in the advertising management server device 13, although the advertising lines could be stored in the plurality of content provider server devices 14(1)-14(n), the plurality of advertising content provider server devices 15(1)-15(n), and/or other locations.

In step 102, the end user computing device 12 determines whether there is a voice activated advertising compression proxy module 38 already downloaded, although other manners for determining whether the voice activated advertising compression proxy module 38 or other related instructions have already been installed can be used. If in step 102, the end user computing device 12 determines the voice activated advertising compression proxy module 38 is not already installed, then the No branch is taken to step 104.

In step 104, the end user computing device 12 downloads and installs the voice activated advertising compression proxy module 38 from the advertising management server device 13, although the module can be obtained and installed in other manners and from other sources, such as from one of the content provider server devices 14(1)-14(n) or one of the advertising content server providers 15(1)-15(n) by way of example only. Once installed, the voice activated advertising compression proxy module 38 can manage an amount of, and type of, items of advertising content to be output, and also, when the associated one or more items of advertising content are displayed, such as before, during, and/or after the output of the requested content, although this technology can be configured in other manners.

If back in step 102, the end user computing device 12 determines the voice activated advertising compression proxy module 38 is already installed, then the Yes branch is taken to step 106. In step 106, one of the content provider server devices 14(1)-14(n) provides the end user computing device 12 with the requested content, the identity and location of one or more items of advertising content associated with the requested content, information for when to output the one or more items of advertising content, and a respective advertising line, such as a brand name, slogan, brand tagline, or catch phrase by way of example only, for each item of advertising content, although other types and amounts of content and other information can be downloaded from other sources at other times. Additionally, the end user computing device 12 may obtain the identified one or more items of associated advertising content from the identified one or more locations, such as one or more of the advertising content provider server devices 15(1)-15(n), as needed, although the items of associated advertising content can be obtained at other times and from other sources. Although in this example the list of advertising lines is provided by the advertising management server device 13, the one or more advertising lines can be obtained from other sources and at other times, such as from one of the content provider server devices 14(1)-14(n) or one of the advertising content provider server devices 15(1)-15(n) by way of example only. Additionally, a list of advertising lines associated respectively with items of advertising content may be downloaded to the end user computing device 12 at a different time from the time of the download of the requested content. In this example, a temporary table may be created in the memory 20 of the end user computing device 12 to store the advertising lines along with their association to items of advertising content.

In step 108, the voice activated advertising compression proxy module 38 in the end user computing device 12 monitors an output of the requested content and controls the output to either be the requested content from one of the plurality of content server provider devices 14(1)-14(n) or one of the items of the advertising content from one of the plurality of advertising content provider server devices 15(1)-15(n), although other manners for managing when the requested content and/or one of the items of advertising content is output could be used. The voice activated advertising compression proxy module 38 in the end user computing device 12 may manage the output of any of the items of advertising content to occur before, during, and/or after the output of the requested content. In this example, the requested content and/or the item of advertising content are output for display on the display device 32 of the end user computing device 12 using the media player module 41, although the requested content and/or item of advertising content can be output in other manners, such as by broadcast over the speaker 30 of the end user computing device 12 by way of example only.

In step 110, the end user computing device 12 monitors for capture of any audio input with the microphone 28 of the end user computing device 12 during the output of the item of advertising content, although other manners for capturing audio input could be used. The end user computing device 12 may provide a clue or guidance on the desired audio input on the display of the display device 32. For example, the clue or guidance might be the advertising line which needs to be spoken and picked up by the microphone 28 to skip or bypass the item of advertising content being output or to initiate another action. In another example, the clue or guidance might be on how to switch to view a different version of the item of advertising content being output, such as a shortened, cut-down, or other modified version of the item of advertising content by way of example only.

In step 112, the end user computing device 12 converts any captured audio input from the microphone 28 using the voice recognition module 40 to a converted audio input, such as text by way of example only. As discussed earlier, the voice recognition module 40 may be trained to one or more voices to improve accuracy.

In step 114, the end user computing device 12 determines whether the output of the item of advertising content has just completed, although other manners for determining when to stop looking for a match could be used. If in step 114, the end user computing device 12 determined the output of the item of advertising content has not just completed, then the No branch is taken to step 115. If in step 114, the end user computing device 12 determined the output of the item of advertising content has just completed, then the Yes branch is taken to step 118 as described later below.

In step 115, the end user computing device 12 determines whether the converted audio input matches the stored information, such as a stored advertising line, associated with the item of advertising content being output, although other manners for determining a match could be used. For example, the end user computing device 12 may display the advertising line on the display device 32, and the only audio output the microphone 28 needs to capture and the voice recognition software needs to convert is either a “yes” or “no” on whether the displayed advertising line corresponds to the output item of advertising content from one of the plurality of advertising content provider server devices 15(1)-15(n). Since the words “yes” and “no” are shorter than most advertising lines, they are easier to process and require a shorter processing time for the end user computing device 12 to analyze whether the response is a match. Additionally, it is easier for an operator of the end user computing device 12 with an accent or speech impediment to confirm an advertising line using “yes” and “no”, instead of announcing an entire advertising line.

If in step 115, the end user computing device 12 determined the converted audio input does not match the stored information, then the No branch is taken back to step 110 as described earlier herein. If there is no match, then the end user computing device 12 also may provide a display or other notification of the error along with a clue or guidance on the desired audio input, such as a display of the advertising line to be spoken or an audio output of the advertising line over the speaker 30 which helps to further promote the brand by way of example only.

If in step 115, the end user computing device 12 determined the converted audio input does match the stored advertising line, then the Yes branch is taken to step 116. In step 116, the voice activated advertising compression proxy module 38 in the end user computing device 12 executes an action with respect to the remaining output of the item of advertising content.

In this example, the action taken by the voice activated advertising compression proxy module 38 in the end user computing device 12 is to skip or otherwise bypass the remaining output of the item of advertising content, although other types and numbers of action could be taken. For example, the action taken by the end user computing device 12 could be to obtain and output a shortened, cut-down or otherwise modified version of the item of advertising content. Another action which could be taken is to enable redirection to a website of a vendor associated with the item of advertising content, although the redirection could be to other locations. By way of example only, this redirection may provide the opportunity to display additional advertising content, earn a future discount, provide an offer or a free sample, or provide an opportunity to play an interactive game for prizes. Another action which could be taken is to enable the operator to connect to social commentary websites to provide social commentary about the item of advertising content, such as indicating a “like” of the item of advertising content on a social commentary website by way of example only. Yet another action which could be taken is to provide and obtain a response to one or more questions, such as “Is this commercial relevant to you?” by way of example, which information is stored for future marketing analysis by the advertising management server device 13 in this example. Additionally, based on the response to the provided question, such as the one listed above, the end user computing device 12 might execute another action, such as to switch to another item of advertising content if the answer was “No” or to provide an additional question on what type of advertisement might be of interest and then to provide one of that type of advertisement by way of example only.

In addition to the action which can be taken, the advertising management server device 13 also monitors and stores information regarding activities during this exemplary method, although other systems and devices could monitor for and store such information, such as the content delivery billing computing device 16. A variety of different types of information can be monitored and stored during this exemplary process, such as what content was requested, what one or more items of associated advertising content were output, the outcomes of any match determinations, and what actions were taken for any successful match determinations by way of example only.

In step 118, the voice activated advertising compression proxy module 38 in the end user computing device 12 determines whether there is any additional advertising content to be output before providing or returning to the requested content. If in step 118, the voice activated advertising compression proxy module 38 in the end user computing device 12 determines there is additional advertising content to be output before providing or returning to the requested content, then the additional item of advertising content is obtained and output, and then the Yes branch is taken back to step 108 as described earlier herein. If in step 118, the voice activated advertising compression proxy module 38 in the end user computing device 12 determines there is no additional item of advertising content to be output, then the No branch is taken to step 120.

In step 120, the voice activated advertising compression proxy module 38 in the end user computing device 12 determines whether there is any remaining requested content to be output. If in step 120, the voice activated advertising compression proxy module 38 in the end user computing device 12 determines there is remaining requested content to be output, then the Yes branch is taken back to step 108 and the output of the requested content is resumed. If in step 120, the voice activated advertising compression proxy module 38 in the end user computing device 12 determines there is no remaining requested content to be output, then the No branch is taken back to step 122.

In step 122, the advertising management server device 13 may provide the information which was stored during the execution of the method, such as what content was requested, what one or more items of associated advertising content were output, the outcomes of any match determinations, and what actions were taken for any successful match determinations by way of example only, to the corresponding one or more of the content provider server devices 14(1)-14(n) which provided each item of requested content or to the source of the item of advertising content, such as one of the advertising content server provider devices 15(1)-15(n), although the stored information can be captured by and/or provided to other types and numbers of systems and devices, such as the content delivery billing computing device 16 to manage any compensation which may need to be invoiced. Additionally, the advertising management server device 13 may optionally perform and provide the results from one or more statistical analyses on this information to the corresponding one or more of the content provider server devices 14(1)-14(n) which provided each item of requested content or to the corresponding one or more of the advertising content server provider devices 15(1)-15(n) which provided the item of advertising content, although the statistical analyses can be performed by and/or provided to other types and numbers of systems and devices. Further, one or more of the content provider server devices 14(1)-14(n) or one or more of the advertising content server provider devices 15(1)-15(n) may optionally determine what compensation is owed based on the received information by way of example only. In step 124, this illustrative example of the method ends.

Accordingly, as illustrated and described with the example herein, this technology provides effective and easier to implement methods, non-transitory computer readable mediums, and apparatuses for voice activated advertisement compression. With this technology, advertising content can be output in a manner which promotes brand retention not only with the operator of the end user computing device, but also with others in the vicinity. Additionally, this technology potentially minimizes display time of items of advertising content which operators prefer. Further, shortening the output of items of advertising content which are acknowledged verbally by a consumer, permits the potential output of more revenue generating items of advertising content in less time while assuring advertisers that their items of advertising content have been effectively delivered to their target audience. Even further, this technology is easily downloaded and implemented as a local proxy on end user computing devices to facilitate more widespread implementation.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for voice activated advertisement compression, the method comprising:
outputting, by an end user computing device, one of one or more items of advertising content associated with requested content;
converting, by the end user computing device, any captured audio input during the outputting of the one of the one or more items of advertising content to a converted audio input;
determining, by the end user computing device, when the converted audio input matches stored information associated with the one of the items of advertising content being output; and
executing, by the end user computing device, an action with respect to the one of the items of advertising content being output when the determining indicates the match between the converted audio input and the stored information.

2. The method as set forth in claim 1 wherein the executing the action further comprises skipping, by the end user computing device, any remaining outputting of the one of the items of advertising content.

3. The method as set forth in claim 1 wherein executing the action by the end user computer stops the outputting of one of the items of advertising content and outputs a different version of one of the items of advertising content.

4. The method as set forth in claim 1 wherein executing the action further comprises redirecting, by the end user computing device, to a website associated with one of the items of advertising content being output.

5. The method as set forth in claim 1 wherein the executing the action further comprises enabling, by the end user computing device, to provide social commentary related to the one of the items of advertising content being output.

6. The method as set forth in claim 1 wherein the executing the action further comprises recording, by the end user computing device, a response to a question related to the one of the items of advertising content being output.

7. The method as set forth in claim 1 further comprising;
determining, by the end user computing device, whether there is another one of the items of advertising content to be output before returning to the outputting of the requested content; and
outputting, by the end user computing device, the other one of the items of advertising content before returning to the outputting of the requested content when the determining indicates there is the another one of the items of advertising content to be output.

8. The method as set forth in claim 1 further comprising providing, by the end user computing device, guidance on the stored information associated with the one of the items of advertising content being output.

9. The method as set forth in claim 1 further comprising recording, by the end user computing device, a log of any activity relating to the requested content or one of one or more items of advertising content.

10. The method as set forth in claim 1 wherein the stored information comprises an acknowledgement of an advertising line and the determining further comprises determining when the converted audio input matches the acknowledgement for the advertising line.

11. The method as set forth in claim 1 wherein the outputting, the converting, the determining, and the executing are managed by a local proxy module in the end user computing device.

12. A non-transitory computer readable medium having stored thereon instructions for voice activated advertisement compression comprising machine executable code which when executed by at least one processor, causes the processor to perform steps comprising:
outputting one of one or more items of advertising content associated with requested content;
converting any captured audio input during the outputting of the one of the one or more items of advertising content to a converted audio input;
determining when the converted audio input matches stored information associated with the one of the items of advertising content being output; and
executing an action with respect to the one of the items of advertising content being output when the determining indicates the match between the converted audio input and the stored information.

13. The medium as set forth in claim 12 wherein the executing the action further comprises bypassing any remaining outputting of the one of the items of advertising content.

14. The medium as set forth in claim 12 wherein the executing the action further comprises stopping the outputting of the one of the items of advertising content and outputting a different version of the one of the items of advertising content.

15. The medium as set forth in claim 12 wherein the executing the action further comprises redirecting to a website associated with the one of the items of advertising content being output.

16. The medium as set forth in claim 12 wherein the executing the action further comprises enabling to provide social commentary related to the one of the items of advertising content being output.

17. The medium as set forth in claim 12 wherein the executing the action further comprises recording a response to a question related to the one of the items of advertising content being output.

18. The medium as set forth in claim 12 further comprising;
determining whether there is another one of the items of advertising content to be output before returning to the outputting of the requested content; and
outputting the other one of the items of advertising content before returning to the outputting of the requested content when the determining indicates there is the another one of the items of advertising content to be output.

19. The medium as set forth in claim 12 further comprising providing guidance on the stored information associated with the one of the items of advertising content being output.

20. The medium as set forth in claim 12 further comprising recording a log of any activity relating to the requested content or one of one or more items of advertising content.

21. The medium as set forth in claim 12 wherein the stored information comprises an acknowledgement of an advertising line and the determining further comprises determining when the converted audio input matches the acknowledgement for the advertising line.

22. The medium as set forth in claim 12 wherein the outputting, the converting, the determining, and the executing are managed by a local proxy module in the end user computing device.

23. A voice activated advertisement compression computing apparatus, the apparatus comprising:
one or more processors;
a memory, the one or more processors configured to execute programmed instructions stored in the memory comprising:
outputting one of one or more items of advertising content associated with requested content;
converting any captured audio input during the outputting of the one of the one or more items of advertising content to a converted audio input;
determining when the converted audio input matches stored information associated with the one of the items of advertising content being output; and
executing an action with respect to the one of the items of advertising content being output when the determining indicates the match between the converted audio input and the stored information.

24. The apparatus as set forth in claim 23 wherein the one or more processors are configured to execute programmed instructions stored in the memory for the executing the action further comprising bypassing any remaining outputting of the one of the items of advertising content.

25. The apparatus as set forth in claim 23 wherein the one or more processors are configured to execute programmed instructions stored in the memory for the executing the action further comprising stopping the outputting of the one of the items of advertising content and outputting a different version of the one of the items of advertising content.

26. The apparatus as set forth in claim 23 wherein the one or more processors are configured to execute programmed instructions stored in the memory for the executing the action further comprising redirecting to a website associated with the one of the items of advertising content being output.

27. The apparatus as set forth in claim 23 wherein the one or more processors are configured to execute programmed instructions stored in the memory for the executing the action further comprising enabling to provide social commentary related to the one of the items of advertising content being output.

28. The apparatus as set forth in claim 23 wherein the one or more processors are configured to execute programmed instructions stored in the memory for the executing the action further comprising recording a response to a question related to the one of the items of advertising content being output.

29. The apparatus as set forth in claim 23 wherein the one or more processors are configured to execute programmed instructions stored in the memory further comprising;
determining whether there is another one of the items of advertising content to be output before returning to the outputting of the requested content; and
outputting the other one of the items of advertising content before returning to the outputting of the requested content when the determining indicates there is the another one of the items of advertising content to be output.

30. The apparatus as set forth in claim 23 wherein the one or more processors are configured to execute programmed instructions stored in the memory further comprising providing guidance on the stored information associated with the one of the items of advertising content being output.

31. The apparatus as set forth in claim 23 wherein the one or more processors are configured to execute programmed instructions stored in the memory further comprising recording a log of any activity relating to the requested content or one of one or more items of advertising content.

32. The apparatus as set forth in claim 23 wherein the stored information comprises an acknowledgement of an advertising line and wherein the one or more processors are configured to execute programmed instructions stored in the memory for the determining further comprising determining when the converted audio input matches the acknowledgement for the advertising line.

33. The apparatus as set forth in claim 23 wherein the outputting, the converting, the determining, and the executing are managed by a local proxy module.
